(19) United States
(12) Patent Application Publication
(10) Pub. No.: US 2025/0128634 A1
(43) Pub. Date: Apr. 24, 2025

(54) METHODS AND SYSTEMS FOR ELECTRIC VEHICLE CHARGING

(71) Applicant: The Hong Kong University of Science and Technology, Hong Kong (CN)

(72) Inventors: Jiheng ZHANG, Hong Kong (CN); Wenzhi KONG, Hong Kong (CN)

(21) Appl. No.: 18/909,016

(22) Filed: Oct. 8, 2024

Related U.S. Application Data
(60) Provisional application No. 63/591,450, filed on Oct. 19, 2023.

(51) Int. Cl. B60L 53/67; B60L 53/62

(52) U.S. Cl. CPC B60L 53/67; B60L 53/62

(57) ABSTRACT

A method is provided for charging one or more electric vehicles. The method comprising: receiving, by a master charging pile, real-time available current information related to a main power supply; receiving, by the master charging pile, latest charging current information related to the master charging pile and one or more slave charging piles, the latest charging current information comprising charging modes and a list of requested charging current for the master charging pile and the one or more slave charging piles; generating, by the master charging pile, charging control signals by processing the real-time available current information and the latest charging current information by applying a load balancing algorithm; and applying the charging control signals to the master charging pile and the one or more slave charging piles for controlling charging of the one or more electric vehicles.

### CROSS-REFERENCE TO RELATED APPLICATIONS

This application claims priority to the U.S. provisional patent application Ser. No. 63/591,450, filed Oct. 19, 2023, entitled “Offline Auto Load Balancing Algorithm for Multiple EV Charging Piles”, hereby incorporated herein by reference as to its entirety.

### FIELD OF THE DISCLOSURE

The present disclosure generally relates to electric vehicle (EV) charging.

### BACKGROUND

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

In recently years, the numbers of EVs and Plug in Hybrid Electric Vehicles (PHEVs) have been rapidly increasing as they can reduce pollution and CO₂ emissions compared to traditional gasoline vehicles. The increased popularity of EVs also reduces dependence on fossil fuels.

A series of international standards have been developed to govern the EV charging. For example, the IEC 61851 series standards, developed by the International Electrotechnical Commission (IEC), are among the earliest international standards for charging systems and serve as important references for the development of similar standards in other countries, such as the SAE J1772 standard in the United States and the GB/T standard in China. For these standards, there are four modes of electric vehicle supply equipment (EVSE), with Mode 3 and Mode 4 capable of communicating with EVs to facilitate smart charging strategies. Mode 4 charging stations are high-power direct current (DC) stations designed for commercial use, requiring support from high-capacity grids with upgraded hardware facilities.

However, EV charging still encounters significant challenges in various aspects. For example, the number of charging stations is far fewer than the number of EVs. This hinders the expectations that charging should be completed quickly, especially when time is limited. Accordingly, this raises the issue of how to better allocate electrical energy resources. As another example, a large number of EV charging at high power simultaneously can lead to system overload and reduced load capacity.

### SUMMARY

According to one or more embodiments, there is provided a method for charging one or more electric vehicles. The method comprising: receiving, by a master charging pile, real-time available current information related to a main power supply; receiving, by the master charging pile, latest charging current information related to the master charging pile and one or more slave charging piles, the latest charging current information comprising charging modes and a list of requested charging current for the master charging pile and the one or more slave charging piles; generating, by the master charging pile, charging control signals by processing the real-time available current information and the latest charging current information by applying a load balancing algorithm; and applying the charging control signals to the master charging pile and the one or more slave charging piles for controlling charging of the one or more electric vehicles.

According to one or more embodiments, there is provided a system for charging one or more electric vehicles. The system comprises a master charging pile and one or more slave charging piles communicating with the master charging pile. Each of the master charging pile and the one or more slave charging piles is configured for charging a corresponding electric vehicle of the one or more electric vehicles. The master charging pile is configured for: receiving real-time available current information related to a main power supply; receiving latest charging current information related to the master charging pile and the one or more slave charging piles, the latest charging current information comprising charging modes and a list of requested charging current for the master charging pile and the one or more slave charging piles; generating charging control signals by processing the real-time available current information and the latest charging current information by applying a load balancing algorithm; and applying the charging control signals to the master charging pile and the one or more slave charging piles for controlling charging of the one or more electric vehicles.

Other example embodiments are discussed herein.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure.

FIG. 1 illustrates a system for charging one or more electric vehicles according to certain embodiments of the present disclosure.

FIG. 2 illustrates a hardware architecture implemented in a charging pile according to certain embodiments of the present disclosure.

FIG. 3 illustrates a hardware implementation for the phase reconfiguration module of a charging pile according to certain embodiments of the present disclosure.

FIG. 4 illustrates a method for charging one or more electric vehicles according to some embodiments of the present disclosure.

FIG. 5 illustrates a method for charging one or more electric vehicles according to some other embodiments of the present disclosure.

FIG. 6 shows actual charging current and predicted required current for single-phase EV charging according to an embodiment of the present disclosure, where C1, C2 and C3 represent the actual charging current.

FIG. 7 shows actual charging current and predicted required current for single-phase EV charging according to another embodiment of the present disclosure, where C1, C2 and C3 represent the actual charging current.

FIG. 8 shows actual charging current and predicted required current for three-phase EV charging according to an embodiment of the present disclosure, where C1, C2 and C3 represent the actual charging current.

FIG. 9 shows actual charging current and predicted required current for three-phase EV charging according to another embodiment of the present disclosure, where C1, C2 and C3 represent the actual charging current.

FIG. 10 shows the electricity data with main fuse 1000A without using any charging management algorithm according to some embodiments of the present disclosure.

FIG. 11 shows the electricity data with main fuse 1000A using an average algorithm according to some embodiments of the present disclosure.

FIG. 12 shows the electricity data with main fuse 1000A using a greedy and compression algorithm (GCA) according to some embodiments of the present disclosure.

### DETAILED DESCRIPTION

The present disclosure will now be described with reference to the following examples which should be considered in all respects as illustrative and non-restrictive.

Throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, etc., to describe a common object, merely indicate that different instances of like objects are being referred to, and are not intended to imply that the objects so described must be in a given sequence, either temporally, spatially, in ranking, or in any other manner.

Example embodiments relate to methods and systems for EV charging with improvement over prior art methods and/or systems.

Many existing EV charging technologies are unsatisfactory in one aspect or another. For example, the presence of single-phase EV charging and the non-ideal charging characteristics of three-phase EV charging leads to significant phase imbalance in the power grid. Various algorithms have been proposed to improve electric vehicle charging management. These algorithms include sequential quadratic optimization, dynamic programming, and heuristic methods. In practical applications, simple averaging algorithms have been used for load balancing. These existing methods are still unsatisfactory in addressing the load unbalancing issues.

For example, many of these existing methods require usage of solvers, especially those algorithms with non-convex objective functions or constraints. As a result, these methods require a substantial amount of computing resources and time. The computing power of the Microcontroller Unit (MCU) of the charging piles is generally weak. Since charging has high real-time requirements, these existing methods may not be suitable for many applications, such as certain non-networked practical scenarios. Further, simple averaging algorithms greatly reduce the utilization of electric energy.

Example embodiments solve one or more of these problems associated with the existing methods and/or systems and provide technical solutions with improved performance.

One or more embodiments provide methods and/or systems having one or more algorithms for achieving dynamic load balancing among multiple alternating current (AC) charging piles or charging stations. Compared with the simple averaging method or algorithm, the experiment results demonstrate that the proposed algorithms improve the utilization of electric energy. Compared with the existing algorithms that consume a large amount of computing resources, the experimental results according to one or more embodiments demonstrate that the proposed algorithms can achieve a satisfactory solution in a reduced time period.

One or more embodiments provide an effective and robust load balancing algorithm that models the charging management of EVs under multiple charging piles as a three-machine scheduling problem and solves it using a novel greedy and compression algorithm (GCA). The GCA prevents overload, improves energy utilization, and balances phases. According to one or more embodiments, real-world constraints (for example, the three-phase EVs can support both three-phase charging and single-phase charging, while the single-phase EVs can have the charging phase controlled) are considered in the algorithm.

In addition to being implemented online, the proposed algorithms can also be deployed offline in charging stations with limited computing resources. Charging stations may be situated in areas with poor network connectivity, such as underground or outdoor parking lots, making an offline deployable algorithm more dependable. Meanwhile, a corresponding feasible hardware framework and the fundamental charging piles hardware architecture are proposed. Experiments have been conducted using generated datasets under different capacity conditions and real-world datasets and demonstrate the effectiveness of the proposed load balancing algorithm.

One or more embodiments innovatively model a multi-pile EV charging problem in a home three-phase circuit system as a multi-machine scheduling problem. The multi-machine scheduling problem assumes that there are n independent jobs to be processed by m machines, where job i requires time tᵢ and the optimal job scheduling solution is obtained based on different requirements. According to one or more embodiments, the innovative approach is to treat the requested charging current by each EV from the corresponding charging pile as a job in the scheduling problem, and the remaining current of each phase as the processing capacity of the machine. To solve this problem, the employed GCA achieves a satisfactory solution in a short time. The GCA can obtain a relatively optimal solution for the multi-machine scheduling problem, and its solving process is relatively simple and fast. In some embodiments, compared with the solutions obtained based on the optimization algorithm, the proposed algorithm has significantly reduced the computation complexity and time spent.

Additionally, the present inventors have recognized that phase reconfiguration can provide certain technical benefits for EV charging by improving its charging management. In this regard, the present inventors have proposed a phase reconfiguration mechanism with related algorithms for aligning the input phases of the power grid with different output phases. Experiments results according to one or more embodiments demonstrate that the proposed phase reconfiguration mechanism enhances energy efficiency and phase balancing. Furthermore, employment of the proposed phase reconfiguration mechanism allows for flexible management, such as providing charging to three-phase electric vehicles in a single-phase charging mode.

According to the IEC 61851 standard, charging stations may only communicate the maximum charging current limit independent of phase to EVs through Control Pilot (CP). That said, the IEC 61851 standard imposes a restriction that charging current for EVs cannot exceed a maximum current, denoted as I_{approved}. In some embodiments, I_{approved} is also called maximum approved charging current. A charging controller in an EV can adjust the charging current based on the value of I_{approved}. Typically, I_{approved} for AC charging stations falls within the range from about 6A to 32A. This range may vary in practical applications. Note that I_{approved} is phase-independent, meaning that each phase of the three-phase charging must remain below this value.

Regarding the maximum current required by the IEC 61851 standard, existing methods typically set a fixed current value as the required current for EVs. These methods do not take account of the differences (such as actual status and needs) of various charging piles for EV charging, and therefore are unable to distribute the electrical energy efficiently and equitably among the charging piles and/or EVs under charging.

In this regard, one or more embodiments introduce an EV charging required current prediction algorithm to forecast the required charging current. The forecast or predicted required charging current is used as requested charging current provided to a master charging pile for load balancing algorithm approval, thereby enhancing efficiency.

The present inventors have further noted that existing methods often overlook fairness or simply use averaged values by assuming all EVs and/or charging piles have same charging requirements. The methods and/or systems according to one or more embodiments, by implementing the required current prediction algorithm, enable an on-demand allocation and achieve proportional fairness, which improves the efficiency of energy distribution and usage.

One or more embodiments provide a feasible hardware framework including a charging piles hardware architecture. The methods and/or systems according to one or more embodiments, by implementing the proposed algorithms, can be implemented in relatively common embedded hardware (such as MCU, Digital Signal Processor (DSP)) for achieving satisfactory results.

Various experiments have been conducted by the present inventors to investigate the performance and robustness of methods and systems that implement one or more algorithms as illustrated here. For testing purposes, randomly generated data and/or real-world data are used. These results demonstrate superior performance across most, if not all, metrics compared to prior art uncoordinated charging and the average algorithm that lacks phase reconfiguration functionality.

To ensure practical applicability, one or more embodiments adhere to the limitations set by the IEC 61851 series standards and focus on the Mode 3 type of AC EVSE as specified in the IEC 61851 standard. It will be understood that these present merely non-restrictive examples illustrating the inventive concept and effectiveness of one or more aspects of the present disclosure.

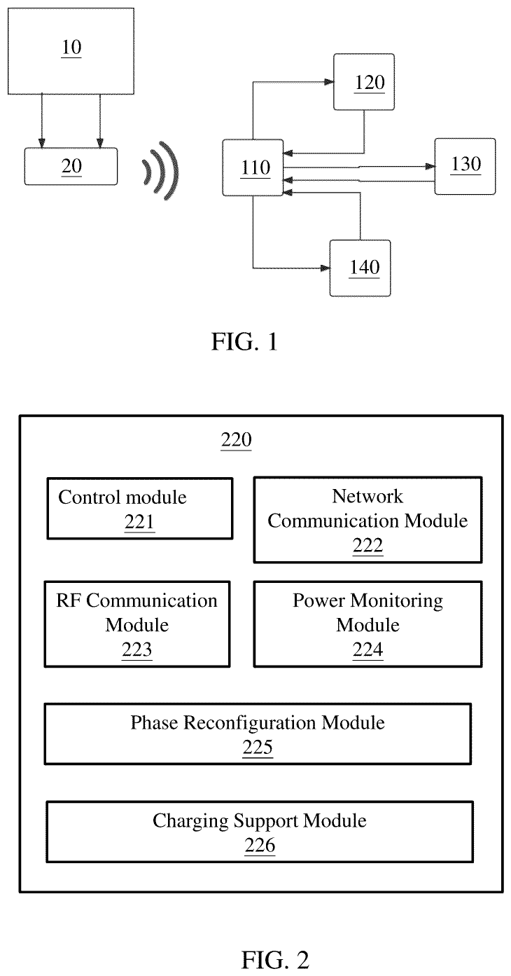

FIG. 1 illustrates a system for charging one or more EVs according to certain embodiments of the present disclosure.

As illustrated, the system comprises a master charging pile 110 and three slave charging piles 120, 130, and 140. The slave charging piles 120, 130, and 140 communicate with the master charging pile 110 for information exchange. For example, the slave charging piles can send their information to the master charging pile. The information, for example, may comprise charging modes (e.g., single-phase or three-phase) and the requested charging current. The master charging pile can send control signals (such as approved charging current) to the slave charging piles for controlling EV charging. The communication can be realised through wired or wireless connections. The number of the slave charging piles may vary from one to more than three. The master charging pile and all the slave charging piles are configured for charging EVs. When all the charging piles are occupied, incoming EVs will wait in line. Any of the slave charging piles may be properly modified to function as a master charging pile. The modification, for example, may include configuring the slave charging pile in a way such that it includes and executes one or more load balancing algorithms and communicates with one or more other components as described herein, thereby to perform the functions and achieve the results of the master charging pile according to one or more embodiments.

The master charging pile 110 communicates with an electric energy detection device 20. The electric energy detection device 20, for example, can comprise one or more current sensors. The electric energy detection device 20 connects to a main power supply (such as a power grid) via a distribution box 10 in this embodiment. The electric energy detection device 20 detects the actual current of each of three phases of the main power supply. For each phase, the detected current is subtracted from the preset main fuse current to obtain residual available current. The residual available current is provided to the master charging pile 110, such as through wireless communication.

FIG. 2 illustrates a hardware architecture 220 implemented in a charging pile according to certain embodiments of the present disclosure. The hardware architecture 220 can be implemented in one or more of the master charging pile and slave charging piles, such as those described above with reference to FIG. 1.

As illustrated, the hardware architecture 220 comprises a control module 221, a network communication module 222, a Radio Frequency (RF) communication module 223, a power monitoring module 224, a phase reconfiguration module 225, and a charging support module 226. By way of example, the control module 221 comprises one or more controllers for signal processing and generating. The network communication module 222 comprises hardware and/or software components that enable one or more devices as described herein to communicate with one or more of the other devices over certain protocol, including but not limited to, Ethernet, Wi-Fi, Bluetooth, CAN Bus, Zigbee, etc. The RF communication module 223 comprises hardware and/or software that enables the sub-1 GHz communication, such as one or more of LoRa, Zigbee, Wi-sum, etc. The power monitoring module 224 comprises components for measuring electrical variables, such as voltage, current, power, frequency, etc. The charging support module 226 comprises one or more components that assist in managing and controlling the charging process for EVs by facilitating safe and efficient charging process.

The phase reconfiguration module 225 comprises one or more hardware and/or software components that dynamically adjust the number of electrical phases used for EV charging depending on factors, such as the available power supply, grid conditions, and the charging pile's capabilities. The phase reconfiguration module 225 may comprise generic computer hardware that is specifically programmed to implement certain algorithms for achieving one or more functions as described herein. The present inventors have recognized that phase reconfiguring is particularly beneficial in that it improves or optimizes charging efficiency and load balancing for the charging system according to one or more embodiments where both single-charging and three-phase charging are available.

When the hardware architecture 220 is implemented in the master charging pile, one or more additional modules, such as those for executing one or more of the load balancing algorithms, are further included. These one or more additional modules, for example, can be implemented as part of certain module as described above, such as the control module 221. It will be appreciated that various modules as shown in the hardware architecture 220 are for illustrative purposes only. The charging piles can be configured differently with one or more modules modified, removed, or replaced. For example, the RF communication module may be replaced with one or more other communication modules as long as necessary communication among devices in the charging system can be achieved. The phase reconfiguration module, while it brings in certain technical advantages to the system and is preferred, is not essential for working one or more of systems and/or methods according to one or more embodiments.

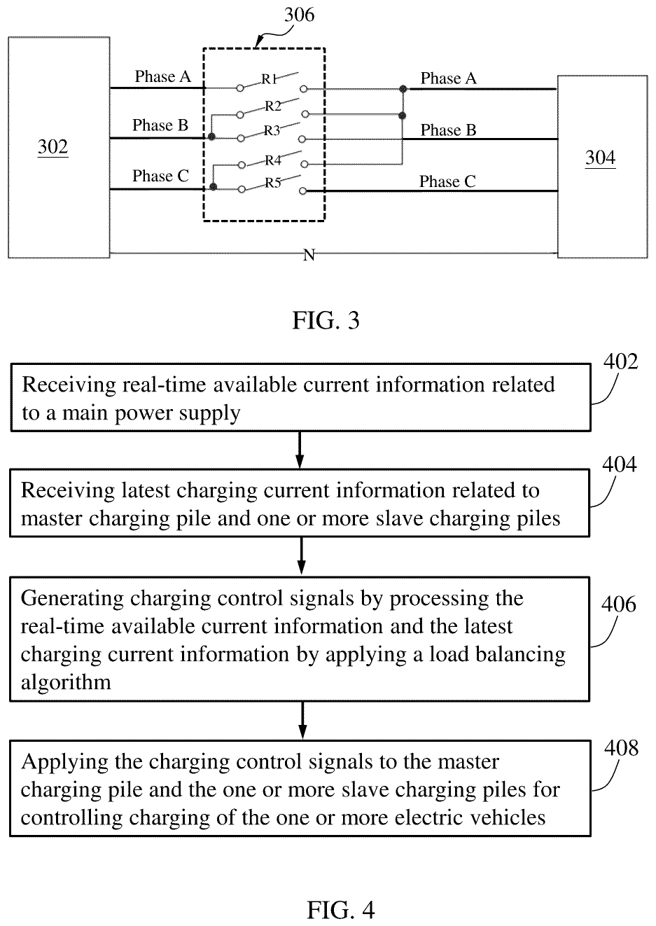

FIG. 3 illustrates a hardware design for the phase reconfiguration module of a charging pile 306 according to certain embodiments of the present disclosure. By way of example, the reconfiguration module can be a specific implementation of the phase reconfiguration module 225 as described above with reference to FIG. 2. The charging pile 306 can be any of the master charging pile and slave charging piles with reference to FIG. 1.

The phase reconfiguration module is disposed within the charging pile 306 and comprises a plurality of relays, denoted as Rₖ, k ∈ 1, . . . , 5, which means k is selected from a set consisting of 1, 2, 3, 4, and 5. The number of the relays can vary according to practical needs. On the left is the input side of the charging pile 306, which is the output from a distribution grid 302. On the right is the output side of the charging pile 306, which is connected to an EV 304 during charging. By way of example, when charging in the single-phase mode, by default, Phase A of the charging pile 306 at its output side is the interface for EV charging input. Therefore, Phase A, Phase B, or Phase C at the input side of the charging pile 306 can be selected to couple to Phase A at the output side of the charging pile 306 via an electrical circuit to achieve phase configuration. Relays can be implemented as switches controllable by voltage levels. In this embodiment, when Rₖ=0, the relay k is open, and current is interrupted and cannot flow through; when Rₖ=1, the relay k is closed, and the current can flow through. By way of example, in the single-phase charging mode, when R₁=1 and R₂=R₃=R₄=R₅=0, Phase A at the input side of the charging pile 306 is coupled to Phase A at the output side of the charging pile 306. This scenario corresponds to a standard single-phase charging mode. In the same single-phase charging scenario, by setting R₂=1 and R₁=R₃=R₄=R₅=0, Phase B at the input side of the charging pile 306 is coupled to Phase A at the output side of the charging pile 306, thereby achieving phase reconfiguration for the single-phase charging by using the grid's Phase B. For three-phase charging, the relays can be set such that R₁=R₃=R₅=1 and R₂=R₄=0. EVs that are capable of three-phase charging can also support single-phase charging. This can be achieved by configuring the relays in a way same as the single-phase charging setup.

It will be appreciated that the above description with reference to FIG. 3 is for illustrative purpose only. For example, the input of the charging pile 306 is not necessarily connected to the output from the distribution grid. When the charging pile 306 is a slave charging pile, the input of the charging pile 306 can be connected to the output of the master charging pile. Further, the relays may be configured as more complicated electrical circuits rather than simple switches.

FIG. 4 illustrates a method for charging one or more EVs according to some embodiments of the present disclosure. For example, the method can be implemented by the master charging pile and/or one or more slave charging piles as described above with reference to one or more embodiments.

Block 402 states receiving real-time available current information related to a main power supply. For example, the real-time available current information comprises residual available current received by a master charging pile from an electric energy detection device.

Block 404 states receiving latest charging current information related to the master charging pile and one or more slave charging piles. For example, the master charging pile can performance one or more actions and/or execute one or more algorithms therein to update and retrieve its information including the charging mode and requested charging current. The master charging pile can poll the one or more slave charging piles to retrieve the charging modes and the requested charging current. The latest charging current information can comprise charging modes and a list of requested charging current for the master charging pile and the one or more slave charging piles. The charging modes can be single-phase charging or three-phase charging, which may depend on which mode the EVs under charging support. Each requested charging current is related to a corresponding charging pile and may be determined based on various parameters, such as actual charging current and latest approved charging current, the number of total EVs under charging, etc. In some embodiments, the requested charging current can be generated by a current prediction algorithm for improving load balancing management. For example, each charging pile can measure the actual charging current used for a connected EV under charging, thereby to obtain measured actual charging current. The charging pile can predict the requested charging current based on the measured actual charging current.

Block 406 states generating charging control signals by processing the real-time available current information and the latest charging current information by applying a load balancing algorithm. The charging control signals can be generated by the master charging pile (such as by the control module therein) and used to control the EV charging. For example, the master charging pile can generate approved charging current so that each of the master charging pile and the slave charging piles knows what current should be applied to charge its connected EV. This can mitigate or reduce load imbalance and improve energy efficiency.

According to one or more embodiments, the list of requested charging current comprises a first group of requested charging current for single-phase charging and a second group of requested charging current for three-phase charging. The first group of requested charging current is sorted in a non-decreasing order, thereby to obtain a sorted first group of requested charging current. The sorted first group of requested charging current is allocated sequentially to least loaded single-charging phases for single-phase charging. This is an iterated process. Once the least loaded single-charging phase is allocated, the second least loaded single-charging phase becomes the least loaded single-charging phase and must be allocated. This iterated process continues until all the single-charging phases are allocated with the sorted first group of requested charging current. Note that the least loaded single-charging phases correspond to those charging piles for charging EVs under a single-phase mode that are least busy. The least loaded status may occur because the related charging pile is idle or the connected EV requires a slow charging (for example, there may be no time urgency, and the EV stays there for an overnight charging). Once all the sorted first group of requested charging current have been allocated, the second group of requested charging current is allocated to the three-charging phases that perform three-phase charging.

After all the requested charging current is allocated, a new list of requested charging current is obtained. This new list of requested charging current can be part of the preliminary charging control signals for controlling EV charging. It is desirable that no charging phase is overload. Therefore, according to one or more embodiments, the preliminary charging control signals are further examined and adjusted to ensure no overloaded phase is present before being used for controlling EV charging. For example, this can be done by comparing the preliminary charging control signals with a maximum approved charging current. The maximum approved charging current can be the maximum current I_{approved} specified by IEC 61851 standard. In some embodiments, the maximum approved charging current is 32A. Specifically, each requested charging current in the preliminary charging control signals is compared with the maximum approved charging current. If all requested charging current is equal to or lower than the maximum approved charging current, that means no overloaded phase. The preliminary charging control signals can be the final charging signals and are provided to the charging piles for controlling EV charging. Otherwise, the requested charging current in the preliminary charging control signals corresponding to an overloaded phase is compressed with a respective compression factor to obtain a compressed charging control signal where the compressed requested charging current is not greater than the maximum approved charging current. In doing so, the issue of phase overloading can be avoided and better performance of EV charging can be achieved.

Block 408 states applying the charging control signals to the master charging pile and the one or more slave charging piles for controlling charging of the one or more electric vehicles. The master charging pile and the slave charging piles, based on the charging control signals, determines the current used for charging the EVs.

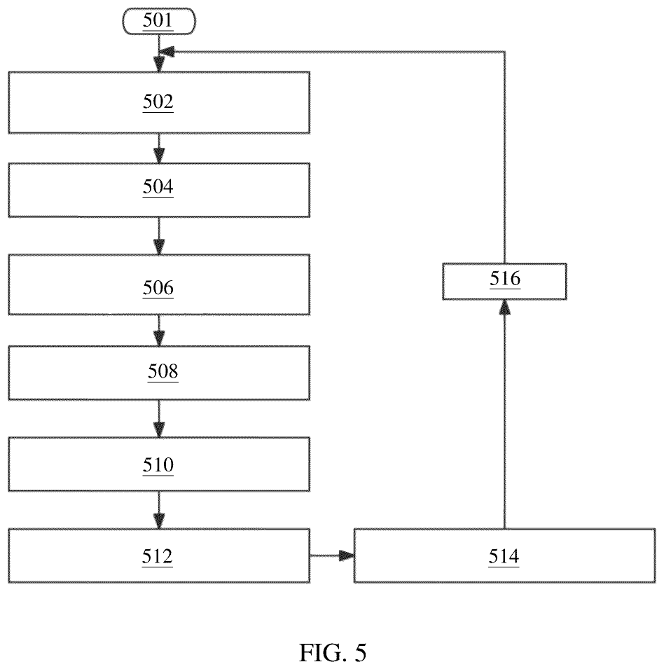

FIG. 5 illustrates a method for charging one or more EVs according to some other embodiments of the present disclosure. For example, the method can be implemented by the master charging pile and/or one or more slave charging piles as described above with reference to one or more embodiments. The method illustrates how one or more of the proposed algorithms, including the load balancing algorithm, are implemented to improve EV charging.

Block 501 states the start of the process. Block 502 states that a current sensor detects and sends the available current information of a distribution box for a main power supply to the master charging pile. The available current information, for example, comprises real-time current on the distribution box side through an electricity detection chip by reading an electricity meter. By pre-setting the main fuse size, real-time available and used current information for the three phases can be obtained.

Block 504 states that a central controller of the master charging pile polls all the charging piles to retrieve charging status and demands including various relevant information. Block 506 states forming a list of requested charging currents for single-phase charging and three-phase charging. By way of example, the master charging pile retrieves the latest real-time actual three-phase charging current information from each of the master charging pile and slave charging piles through polling. The master charging pile also obtains the charging modes (e.g., single-phase or three-phase) and requested charging current. Assuming the number of the master charging pile and the one or more slave charging piles having a single-phase charging mode is N₁, and the number of the master charging pile and the one or more slave charging piles having a three-phase charging mode is N₂, and N=N₁+N₂. N₁, N₂ and N is an integer, and N is equal to or greater than one. N is also the total EVs under charging. Placing the requested charging currents for single-phase charging in the first N₁ items and for three-phase charging in positions from N₁+1 to N₁+N₂, it can be generated a list of requested charging current list_{request_charging_currents}={r₁, . . . , r_{N}_{₁}, r_{N}_{₁}₊₁, . . . , r_{N}_{₁}_{+N}_{₂}} along with the counts of single-phase charging N₁, three-phase charging N₂, and total charging N.

According to one or more embodiments, the list of requested charging current can be generated at all the charging piles through a current prediction algorithm. Each charging pile is implemented with the current prediction algorithm for predicting a corresponding requested charging current. This will be described below by way of example.

The ith (i=1, . . . , N) charging pile conducts real-time measurement of its actual charging current aᵢ for predicting the required charging current dᵢ for EV charging. This predicted required charging current will serve as the corresponding requested charging current rᵢ for the ith charging pile to use in load balancing.

Each charging pile maintains a charging information table to record the details of the current charging session. When a new charging session begins, this table is cleared and updated with fresh data. The illustrative current prediction algorithm can be divided into two stages: an initial stage and a stable stage. The initial stage lasts from the start of EV charging until a predefined initialization time Tᵢₙᵢₜ, and allows time for the EV to stabilize at a constant current state. During this initial stage, the requested charging current is not based on the required charging current but is set as the maximum preset charging current xₘₐₓ (which can be the maximum approved charging current, such as I_{approved}, such as 32A in some embodiments) of the charging piles, and applied in a three-phase charging mode (the three-phase charging mode is initially chosen because it is uncertainty whether the EV supports one-phase charging or three-phase charging). At the end of the initial stage, actual charging current aᵢ is measured. If the measured current for any two phases is zero or close to zero, the EV is considered single-phase charging; otherwise, it is identified as three-phase charging. As such, the charging mode is determined and this charging pile's charging information table is updated.

At the stable stage, the required charging current dᵢ is predicted based on the measured actual charging current aᵢ. Two thresholds, δ_{inc} (first threshold) and δ_{dec} (second threshold), are defined or predetermined. Let cᵢ be the latest approved charging current (i.e. the last approved charging current) by the master charging pile for the ith charging pile. If cᵢ−aᵢ<δ_{inc}, then dᵢ=min (cᵢ+2^{cnt}^{_{inc}}, xₘₐₓ), with cnt_{inc} incremented by 1. cnt_{inc} serves as a counter for consecutive increases and can be set as zero at the very beginning of performing the method of FIG. 5. The symbol ‘min’ means returning to the smaller one of the two values in the bracket. If cᵢ−aᵢ>δ_{dec}, then dᵢ=max(aᵢ+1, 6.0). The symbol ‘max’ means returning to the larger one of the two values in the bracket. If neither condition is met, the required charging current remains dᵢ unchanged, with cnt_{inc} reset to 0. After prediction, the predicted required current dᵢ is used as the requested charging current rᵢ for the ith charging pile, such that rᵢ=dᵢ.

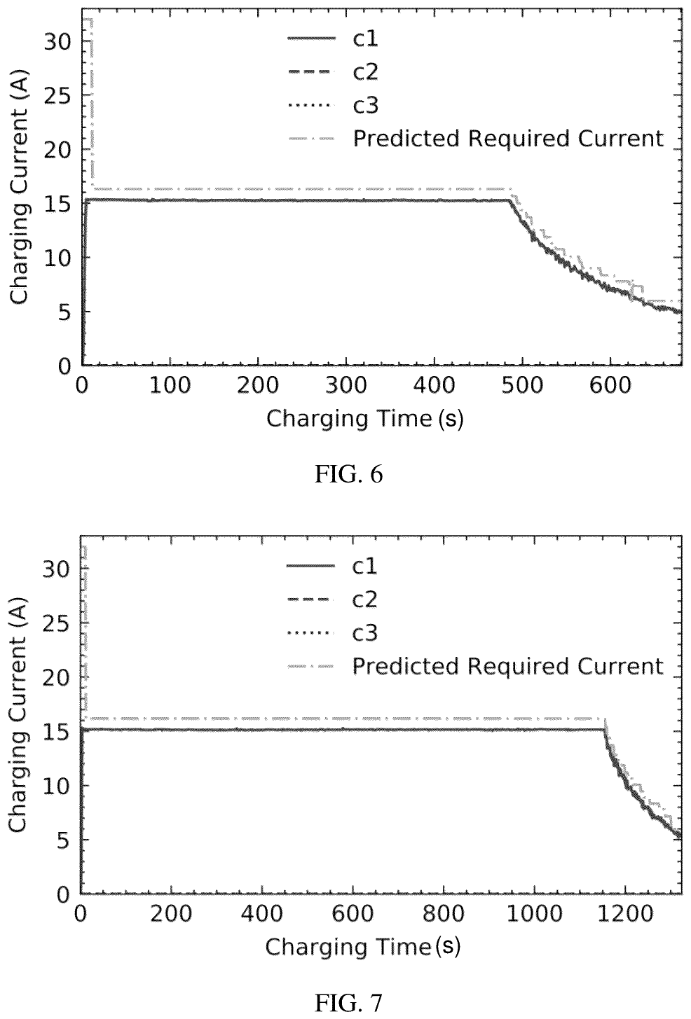

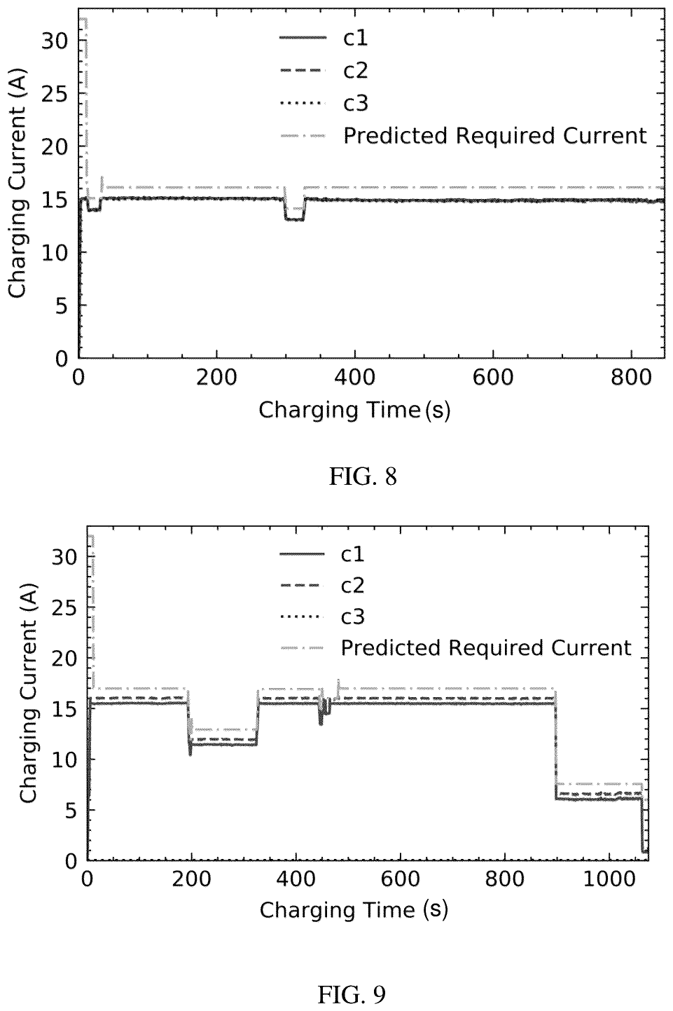

Using the current prediction algorithm, each charging pile device stores the current charging type or charging mode (single-phase or three-phase), real-time charging current information, and requested current information for the ongoing EV charging session. The central controller of the master charging pile can poll each charging pile (including the master charging pile) to retrieve such information. According to some embodiments, to demonstrate the effectiveness of the current prediction algorithm, let Tᵢₙᵢₜ=120 second, δ_{inc}=0, and δ_{dec}=1.5. The current prediction algorithm is applied to real-world charging data for single-phase and three-phase charging, and the results are shown in FIG. 6, FIG. 7, FIG. 8 and FIG. 9. In these figures, C1, C2, and C3 represent the measured actual charging current. The real charging dataset is obtained with 10-second intervals, i.e., recorded every 10 seconds. These figures also show the predicted required current using the proposed current prediction algorithm. FIGS. 6 and 7 correspond to single-phase charging and thus both C2 and C3 are substantially zero. As can be seen, the current prediction algorithm can closely track the changes in charging data and adjust the accuracy by modifying the values of δ_{inc} and δ_{dec}.

Referring again to FIG. 5, Block 508 states data preprocessing. The data or information received from the current sensor and all the charging piles are processed at the master charging pile. The master charging pile takes into account of various power-related information, such as the household loads, the current used by slave charging piles, etc. By summing the real time available three-phase current information from the current sensor with the real three-phase charging current information from all the slave charging piles, the phase j (j Σ 1, 2, 3) available current information I_{avail_j} excluding EV charging can be obtained. Therefore, I_{avail_j} can be expressed as “the real time available three-phase current information from the current sensor” plus “the real three-phase charging current information from all charging piles including the master charging pile and the slave charging piles. The following items can be input for the load balancing algorithm: phase j (j Σ {1,2,3}) available current information I_{avail_j}, phase j (j ∈ {1, 2, 3}) fix current information I_{fix_j}, a list of requested charging currents list_{request_charging_currents}={r₁, . . . , r_{N}_{₁}, r_{N}_{₁}₊₁, . . . , r_{N}_{₁}_{+N}_{₂}}, the counts of single-phase charging N₁, and the counts of three-phase charging N₂. The fix current information refers to the current associated with the system, such as the current required by household appliances. For a certain system, it cannot be adjusted. Rather, it can be used as known constraints for the algorithm.

Block 510 states executing the online and/or off-line algorithms. The output of the algorithm is a list of charging control signals, where the first N items represent the load balancing control factors {λ₁, . . . , λᵢ, . . . , λ_{N}}, and the subsequent N items correspond to the approved charging currents {c₁, . . . , cᵢ, . . . , c_{N}}, with a one-to-one correspondence between the two sets. The N items align with the requested charging current information in list_{request_charging_currents}. Therefore, after running the algorithm, the charging control signals represented by the list_{charging_controls}={λ₁, . . . , λ_{N}, c₁, . . . , c_{N}} can be obtained.

Below is an example illustrating how the load balancing algorithm is specifically implemented. One of the algorithm's tasks is to equitably distribute the three-phase available current Iₐᵥₐᵢₗ to each charging pile based on the respective requested charging current for load balancing control. This can be formulated as a parallel identical three-machine scheduling problem with a maximum completion time constraint.

The parallel identical multi-machines scheduling problem can be defined as follows. There are n tasks that need to be scheduled on m identical machines. Each task j, where j=1, . . . , n, requires tⱼ units of time for processing on a machine. Each machine can handle only one task at a time. The objective is to allocate the n tasks to the m identical machines to minimize the completion time. In the context of load balancing, the three phases can be viewed as three identical machines, where tasks and their processing times can be likened to single-phase charging piles and their requested currents. As such, scheduling the requested charging currents for the single-phase charging between the three phases actually represents a three-machine scheduling challenge. As for the requested charging currents of the three-phase charging piles, they can be straightforwardly distributed across all three phases simultaneously. Additionally, the constraint on three-phase available current is equivalent to a maximum completion time restriction. To address this, compression algorithms are employed.

Further, the multi-machine scheduling problem is an NP-hard problem, yet numerous heuristic algorithms have shown effective performance in large-scale engineering problems, such as the Shortest Processing Time (SPT) algorithm based on greedy principles. One or more embodiments introduce a heuristic algorithm based on greedy and compression, with the specific steps follows.

### Greedy-Based Initialization Allocation Stage

The requested charging current for single-phase charging (the first N₁ items from list_{request_charging_currents}, i.e. {r₁, . . . , r_{N}_{₁}}) is sorted in non-decreasing order. And then each single-phase requested charging current is allocated sequentially to the least loaded single-charging phase. That is, the sorted {r₁, . . . , r_{N}_{₂}} are allocated to be the approved charging current of {c₁, . . . , c_{N}_{₁}}. Subsequently, the requested charging current for three-phase charging are allocated to all three-charging phases. That is, {r_{N}_{₁}₊₁, . . . , r_{N}} is allocated to be the approved charging current of {c_{N}_{₁}₊₁, . . . , c_{N}}. Accordingly, a preliminary result of load balancing control list_{charging_controls_preliminary}={λ₁, . . . , Δ_{N}, c₁, . . . , c_{N}} is obtained. The preliminary result represents preliminary charging control signals. Regarding the load balancing control factor {λ₁, . . . , λᵢ, . . . , λ_{N}}, for single-phase charging, if Phase A is the least loaded phase, λᵢ=1. Similarly, if it is Phase B, λᵢ=2, and if it is Phase C, λᵢ=3. If it is the three-phase charging, λᵢ=4. The preliminary charging control signals will be examined to ensure that none of the phases is overloaded. This can be achieved by comparing each cᵢ with a maximum approved charging current, such as 32A. Only when no element in {c₁, . . . , c_{N}} exceeds the maximum approved charging current, the preliminary charging control signals can be considered as valid and applicable to the slave charging piles. Otherwise, the preliminary charging control signals must be further processed by going through an overload compression stage.

### Overload Compression Stage

In the presence of one or more overloaded phases, the compression algorithm can be implemented. Let c_{i_min} be a minimum approved charging current. The minimum approved charging current may be imposed by the system or certain industrial standard. In some embodiments, c_{i_min}=6.0A. According to one or more embodiments, compression is not applied to the entirety of the requested charging current {r₁, . . . , rᵢ, . . . , r_{N}_{₁}}) in the preliminary charging control signals, but to the redundant current zᵢ=rᵢ−c_{i_min}. The overload compression process unfolds as follows: a loop is initiated, where if the process has completed a preset number (such as three) full iterations or the result is valid, the loop exits, and the result is returned. Firstly, identify the most severely overloaded phase J_{most_overloading}. The term “most severely overloaded phase” refers to the electrical phase in that experiences the highest degree of overload, meaning it carries a current that exceeds its designated current limit by the largest margin. Secondly, calculate the compression factor k for phase j_{most_overloading}, where:

$$k = \frac{redundant\_current \_sum - overload\_part \_value}{redundant\_current \_sum} , \\ redundant\_current \_sum = {\sum }_{i = 1}^{N} {z}_{i} , \\ overload\_part \_value = {\sum }_{i = 1}^{N} φ ( {j}_{most \_ overloading} , {λ}_{i} ) {r}_{i} - {I}_{avail \_ {j}_{most \_ overloading}} , \\ φ ( j , {λ}_{i} ) = \{ \begin{matrix}1 , & if {λ}_{i} = 4 or {λ}_{i} = j \\ 0 , & otherwise\end{matrix} .$$

For the requested charging current for single-phase charging, the compressed value is determined as CVⱼ_{_{most_overlaoding}}=c_{i_min}+zᵢ*k. The compressed value CVⱼ_{_{most_overloading}} is then allocated as the new approved charging current such that cⱼ_{_{most_overloading}}=CVⱼ_{_{most_overloading}}. The calculation method for compressing the requested charging currents for three-phase charging is similar to the method for single-phase charging but necessitates updating values on the other two phases by using the same new approved charging current as calculated. This is because the approved charging current for all three phases in a three-phase charging should be equal. Therefore, if there is a change in Phase j_{most_overloading}, the other two phases also need to be updated accordingly. After compression, the loop restarts. Finally the updated or new charging control signals list_{charging_controls}={λ₁, . . . , λ_{N}, c₁, . . . , c_{N}} are obtained for load balancing control. The new charging control signals do not include any overloaded phase and therefore can achieve an improved balanced load control for EV charging.

Block 512 states informing each charging pile of the corresponding load balancing factor and approved charging current. Block 514 states that each charging pile applies the charging control in the current EV charging session. Block 516 states the next time step and repeat the steps in the preceding blocks such that the load control is a dynamic and real-time process. For example, the time step value can be set to 10 seconds. The time step value can be adjusted in real-world applications based on specific requirements to increase or decrease the time step duration.

The methods as described above with reference to FIG. 4 and FIG. 5 are for illustrative purpose only. It will be understood the one or more steps may be optionally and/or can be configured differently. The method steps of FIGS. 4 and 5 may be combined in a number of ways as understood by the person skilled in the art. The method steps of FIGS. 4 and 5 may also be based to develop modified or new steps.

According to one or more embodiments, experiments are conducted to investigate the performance and robustness of the algorithms, such as the GCA. The CGA is tested by using both randomly generated data and real-world data. The results are compared with those based on the prior art uncoordinated charging and average strategy algorithms. The analysis includes overload rate, approved charging EV rate, actual utilization rate, fairness, maximum phase difference, algorithm runtime, and peak shaving effect.

### Experiment Settings

In one or more embodiments, the experiments are conducted on a 12th Gen Intel® Core™ i5-12400@2.50 GHz, 8.00 GB, Windows 10 system. All experimental code is written in Python 3.10.11. The experiments required two types of data: electricity data from the distribution grid and EV charging data. For experiments with randomly generated data, the EV charging data are generated based on fundamental EV charging characteristics, while the electricity data for the distribution grid are adjusted within a range defined by EV data and a capacity-modifying coefficient. The experiments with real-world data simulate EV charging in a residential area with 100 households. EV charging data are randomly selected from the EV-CPW dataset (by referring to I. Ziyat, A. Gola, P. R. Palmer, S. Makonin, and F. Popowich, “Ev charging profiles and waveforms dataset (ev-cpw) and associated power quality analysis,” IEEE Access, 2023, which is incorporated herein with its entirety) and the EV charging data from Nexblue Smart Charging company. The electricity data for the distribution grid are obtained from three-phase household electricity data in northern Germany by referring to the reference: M. Schlemminger, T. Ohrdes, E. Schneider, and M. Knoop, “Dataset on electrical single-family house and heat pump load profiles in germany,” Scientific data, vol. 9, no. 1, p. 56, 2022, which is incorporated herein with its entirety.

The average results of one hundred sets of generated data experiments are shown in Table 1 and Table 2 below.

TABLE 1
Average performances on the generated datasets. Apart from Approved
Charging EV Rate (ACEVR) and Actual Utilization Rate (AUR) where
higher values indicate better performance, lower values closer
to zero are preferred for the other metrics (Overload Rate (OLR),
Fairness (FAR), Maximum Phase Current Difference (MPCD)). The
three algorithms compared are No Algorithm (NA) (i.e., without
using any algorithm), Average Algorithm (AA), Greedy and Compression
Algorithm (GCA). Bolded markings signify the optimal results
for the two optimization objectives (AUR and FAR).

| MODEL | OLR | ACEVR | AUR | FAR | MPCD |
|---|---|---|---|---|---|
| NA | 0.9800 | 0.0200 | 0.0200 | 0.0000 | 29.1719 |
| AA | 0.0000 | 1.0000 | 0.7988 | 0.0252 | 1238.1231 |
| CGA | 0.0000 | 1.0000 | 0.9671 | 0.0034 | 19.7317 |

Overload occurs when the current usage exceeds the limit set by the main fuse. OLR measures the percentage that the overload occurs. ACEVR indicates the proportion of EVs that are approved for charging relative to the total demand, under the same capacity conditions. AUR reflects how efficiently EV charging utilizes electricity from the grid. Ideally, it should be the ratio of the approved current to the available current. The present inventors have recognized that, however, when the requested current is low (e.g., potentially due to fewer charging vehicles), this rate can be misleading and may not accurately reflect the effectiveness of load balancing algorithms. Therefore, the present inventors introduce herein the concept of AUR, as shown in the formula below:

$$AUR = \{ \begin{matrix}\frac{approved\_current}{requested\_current} & if requested\_current < available\_current , \\ \frac{approved\_current}{available\_current} & otherwise\end{matrix} .$$

When the requested current is less than the available current, the AUR is the ratio of the approved current to the requested current, thereby providing a better representation of the algorithm's scheduling effectiveness. Note that here the terms “approved_current” and “approved current” have the same meaning as the term “approved charging current”, and the terms “requested_current” and “requested current” have the same meaning as the term “requested charging current”.

It is desirable that the ratio of the approved current to the requested current is as equal as possible for each EVSE. FAR is measured using the variance of this ratio as the standard fairness indicator in the one or more experiments as described herein.

MPCD is the maximum phase currents difference. Phase imbalances can lead to various issues. For example, German regulations stipulate that the maximum phase currents difference should be less than 20A.

TABLE 2
Average runtime (ART) on the generated datasets.
The two algorithms compared are Greedy and Compression
Algorithm (GCA), NSGA-II Algorithm (NSGA-II). Bolded
markings signify the optimal results.

| MODEL | ART |
|---|---|
| CGA | 0.0005 (s) |
| NGCA-II | 1.7450 (s) |

It can be seen from these results that compared to the no algorithm (absence of any charging management algorithms) and the commonly used average algorithm without phase configuration, the proposed algorithm achieves significant improvements in various aspects, such as energy efficiency, prevention of overload, phase balancing, and fairness.

Further, in comparison to resource-intensive algorithms, specifically Non-dominated Sorting Genetic Algorithm II (NSGA-II), a classic algorithm in multi-objective optimization, the proposed algorithm has significantly shorter runtime (e.g. in this example, the average runtime is only 0.0005 seconds).

Experiment with Real-World Data

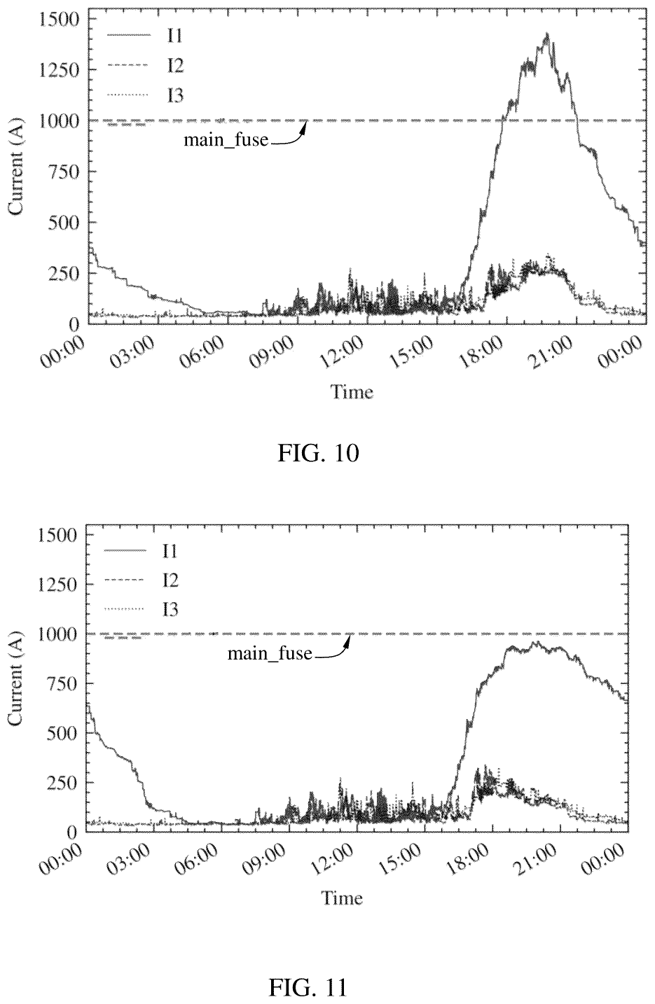

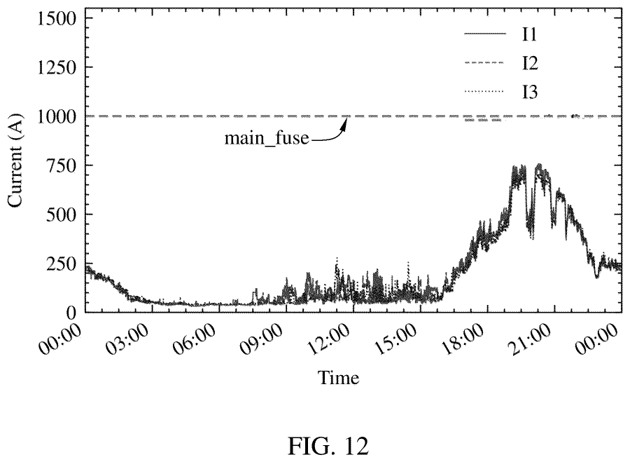

With the main fuse set at 1000A, the electricity consumption data throughout a day under different algorithms in the real-world data experiment are illustrated in FIG. 10, FIG. 11, and FIG. 12.

It can be observed that the proposed methods, with the implemented GCA, effectively reduce peak current values and balance current among phases. In contrast, the prior art uncoordinated charging and average algorithm without phase reconfiguration tend to lead to exceptionally high peak current values in phase A due to inefficient energy utilization, especially with uncoordinated charging resulting in prolonged overload occurrences. Additionally, significant three-phase imbalance is observed.

As used herein, the terms “charging pile” and “charging station” are used interchangeably.

It will further be appreciated that any of the features in the above embodiments of the disclosure may be combined together and are not necessarily applied in isolation from each other. Similar combinations of two or more features from the above described embodiments or preferred forms of the disclosure can be readily made by one skilled in the art.

Unless otherwise defined, the technical and scientific terms used herein have the plain meanings as commonly understood by those skill in the art to which the example embodiments pertain. It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed is:

1. A method for charging one or more electric vehicles, the method comprising:
receiving, by a master charging pile, real-time available current information related to a main power supply;
receiving, by the master charging pile, latest charging current information related to the master charging pile and one or more slave charging piles, the latest charging current information comprising charging modes and a list of requested charging current for the master charging pile and the one or more slave charging piles;
generating, by the master charging pile, charging control signals by processing the real-time available current information and the latest charging current information by applying a load balancing algorithm; and
applying the charging control signals to the master charging pile and the one or more slave charging piles for controlling charging of the one or more electric vehicles.

2. The method of claim 1, wherein the charging modes are selected from a group consisting of single-phase charging and three-phase charging.

3. The method of claim 2, wherein the list of requested charging current comprises a first group of requested charging current for single-phase charging and a second group of requested charging current for three-phase charging,
wherein generating the charging control signals comprises obtaining preliminary charging control signals by:
sorting the first group of requested charging current in a non-decreasing order, thereby to obtain a sorted first group of requested charging current;
allocating the sorted first group of requested charging current sequentially to least loaded single-charging phases for the single-phase charging, and
allocating the second group of requested charging current to three-charging phases for the three-phase charging.

4. The method of claim 3, wherein generating the charging control signals comprises:
determining whether there is an overloaded phase by comparing the preliminary charging control signals with a maximum approved charging current, and
assigning the preliminary charging control signals to the charging control signals if no overloaded phase is identified.

5. The method of claim 4, wherein generating the charging control signals comprises: if an overloaded phase is identified,
calculating a compression factor; and
applying the compression factor to the overloaded phase to obtain a compressed charging control signal for the overloaded phase.

6. The method of claim 1, wherein receiving the latest charging current information comprises:
polling, by the master charging pile, the master charging pile and the one or more slave charging piles to retrieve the charging modes and the list of requested charging current.

7. The method of claim 1, further comprising:
measuring actual charging current for the master charging pile and the one or more slave charging piles to obtain measured actual charging current; and
predicting the list of requested charging current based on the measured actual charging current.

8. The method of claim 1, further comprising:
reconfiguring phases for input and output of each of the master charging pile and the one or more slave charging piles through relays.

9. The method of claim 1, wherein the number of the master charging pile and the one or more slave charging piles is N, N being an integer and greater than one,
the method further comprises at the ith charging pile of the master charging pile and the one or more slave charging piles, i=1, . . . , N:
during a predefined initialization time period, setting a required charging current dᵢ for the ith charging pile such that dᵢ=xₘₐₓ, xₘₐₓ being a maximum approved charging current;
at the end of the predefined initialization time period, measuring actual charging current aᵢ for the ith charging pile; and
determining a charging mode for the ith charging pile and updating the required charging current dᵢ based on the actual charging current aᵢ.

10. The method of claim 9, further comprising: if cᵢ−aᵢ<δ_{inc}, then,
updating the required charging current dᵢ such that dᵢ=min(cᵢ+2^{cnt}^{_{inc}}, xₘₐₓ), cᵢ being latest approved charging current for the ith charging pile, δ_{inc} being a first threshold, cnt_{inc} being a counter; and
assigning dᵢ to be new approved charging current for the ith charging pile.

11. The method of claim 9, further comprising: if cᵢ−aᵢ>δ_{dec}, then,
dᵢ=max(aᵢ+1, xₘᵢₙ), cᵢ being latest approved charging current for the ith charging pile, δ_{dec} being a second threshold, xₘᵢₙ being a minimum approved charging current; and
assigning dᵢ to be new approved charging current for the ith charging pile.

12. The method of claim 1, wherein receiving the latest charging current information comprises: polling, by the master charging pile, the master charging pile and the one or more slave charging piles to retrieve the latest charging current information from charging information tables, each charging information table being stored in a corresponding charging pile,
wherein each charging information table comprises a charging mode, actual charging current, and required charging current for the corresponding charging pile, the charging mode being either a single-phase charging mode or a three-phase charging mode.

13. The method of claim 1, further comprising: obtaining phase j(j∈1, 2, 3) available current information I_{avail_j} based on the real-time available current information and the latest charging current information.

14. The method of claim 13, wherein the number of the master charging pile and the one or more slave charging piles having a single-phase charging mode is N₁, and the number of the master charging pile and the one or more slave charging piles having a three-phase charging mode is N₂, and N=N₁+N₂, N₁, N₂ and N being an integer, N being equal to or greater than one, the list of requested charging current being represented by list_{request_charging_currents}={r₁, . . . , r_{N}_{₁}, r_{N}_{₁}₊₁, . . . , r_{N}_{₁}_{+N}_{₂}},
wherein the charging control signals are represented by list_{charging_controls={λ}_{₁}, . . . , λᵢ, . . . , λ_{N}, c₁, . . . , cᵢ, . . . , c_{N}}, λᵢ representing a load balancing control factor for the ith charging pile and being selected from a group consisting of 1, 2, 3, and 4, cᵢ representing approved charging current for the ith charging pile,
wherein generating the charging control signals comprises obtaining preliminary charging control signals by:
sorting {r₁, . . . , r_{N}_{₁}} in non-decreasing order;
allocating sorted {r₁, . . . , r_{N}_{₂}} as {c₁, . . . , c_{N}_{₁}} to least loaded single-charging phases for single-phase charging; and
allocating {r_{N}_{₁}₊₁, . . . , r_{N}} as {c_{N}_{₁}₊₁, . . . , c_{N}} to three-charging phases for the three-phase charging.

15. The method of claim 14, wherein generating the charging control signals comprises:
determining whether there is an overloaded phase by comparing the preliminary charging control signals with a maximum approved charging current; and
if there is any overloaded phase, then:
calculating redundant current zᵢ=rᵢ—c_{i_min}, c_{i_min} being a minimum approved charging current, zᵢ=1, . . . , N;
repeating a loop until no overloaded phase is present:
identifying a most severely overloaded phase j_{most_overloading};
calculating a compression factor k for phase j_{most_overloading},
$$k = \frac{redundant\_current \_sum - overload\_part \_value}{redundant\_current \_sum} ,$$
$$redundant\_current \_sum = {\sum }_{i = 1}^{N} {z}_{i} ,$$
$$overload\_part \_value = {\sum }_{i = 1}^{N} φ ( {j}_{most \_ overloading} , {λ}_{i} ) {r}_{i} - {I}_{avai \_ {j}_{most \_ overloading}} ,$$
$$calculating a compressed value as \\ {CV}_{{j}_{most \_ overloading}} = {c}_{i \_ min} + {z}_{{j}_{most \_ overloading}} * k ; and$$
$$assigning {CV}_{{j}_{most \_ overloading}} to {c}_{{j}_{most \_ overloading}} such that \\ {c}_{{j}_{most \_ overloading}} = {CV}_{{j}_{most \_ overloading}} ,$$
$$wherein φ ( j , {λ}_{i} ) = \{ \begin{matrix}1 , & if {λ}_{i} = 4 or {λ}_{i} = j \\ 0 , & otherwise\end{matrix} .$$

16. A system for charging one or more electric vehicles, the system comprising:
a master charging pile; and
one or more slave charging piles communicating with the master charging pile, each of the master charging pile and the one or more slave charging piles configured for charging a corresponding electric vehicle of the one or more electric vehicles,
the master charging pile is configured for:
receiving real-time available current information related to a main power supply;
receiving latest charging current information related to the master charging pile and the one or more slave charging piles, the latest charging current information comprising charging modes and a list of requested charging current for the master charging pile and the one or more slave charging piles;
generating charging control signals by processing the real-time available current information and the latest charging current information by applying a load balancing algorithm; and
applying the charging control signals to the master charging pile and the one or more slave charging piles for controlling charging of the one or more electric vehicles.

17. The system of claim 16, wherein the master charging pile is configured for polling the master charging pile and the one or more slave charging piles to retrieve the charging modes and the list of requested charging current.

18. The system of claim 16, wherein each of the master charging pile and the one or more slave charging piles comprises a phase reconfiguration module for reconfiguring phases for input and output of corresponding charging pile through relays.

19. The system of claim 16, wherein the master charging pile is configured for obtaining phase j (j∈1, 2, 3) available current information I_{avail_j} based on the real-time available current information and the latest charging current information,
wherein the number of the master charging pile and the one or more slave charging piles having a single-phase charging mode is N₁, and the number of the master charging pile and the one or more slave charging piles having a three-phase charging mode is N₂, and N=N₁+N₂, N₁, N₂ and N being an integer, N being equal to or greater than one, the list of requested charging current being represented as list_{request_charging_currents}={r₁, . . . , r_{N}_{₁}, r_{N}_{₁}₊₁, . . . , r_{N}_{₁}_{+N}_{₂}},
wherein the charging control signals are represented by list_{charging_controls}={λ₁, . . . , λᵢ, . . . , λ_{N}, c₁, . . . , cᵢ, . . . , c_{N}}, λᵢ representing a load balancing control factor for the ith charging pile and being selected from a group consisting of 1, 2, 3, and 4, cᵢ representing approved charging current for the ith charging pile,
wherein the master charging pile is configured for obtaining preliminary charging control signals by:
sorting {r₁, . . . , r_{N}_{₁}} in non-decreasing order;
allocating sorted {r₁, . . . , r_{N}_{₁}} as {c₁, . . . , c_{N}_{₁}}} to least loaded single-charging phases for single-phase charging; and
allocating {r_{N}_{₁}₊₁, . . . , r_{N}_{₁}_{+N}_{₂}} as {c_{N}_{₁}₊₁, . . . , c_{N}} to three-charging phases for the three-phase charging,
wherein the master charging pile is further configured for:
determining whether there is an overloaded phase by comparing the preliminary charging control signals with a maximum approved charging current; and
if there is any overloaded phase, then:
calculating redundant current zᵢ=r₁−c_{i_min}, c_{i_min} being a minimum approved charging current, zᵢ=1, . . . , N;
repeating a loop until no overloaded phase is present:
identifying a most severely overloaded phase j_{most_overloading};
calculating a compression factor k for phase j_{most_overloading},
$$k = \frac{redundant\_current \_sum - overload\_part \_value}{redundant\_current \_sum} ,$$
$$redundant\_current \_sum = {\sum }_{i = 1}^{N} {z}_{i} ,$$
$$overload\_part \_value = {\sum }_{i = 1}^{N} φ ( {j}_{most \_ overloading} , {λ}_{i} ) {r}_{i} - {I}_{avail \_ {j}_{most \_ overloading}} ,$$
$$calculating a compressed value as \\ {CV}_{{j}_{most \_ overloading}} = {c}_{i \_ min} + {z}_{{j}_{most \_ overloading}} * k ; and$$
$$assigning {CV}_{{j}_{most \_ overloading}} to {c}_{{j}_{most \_ overloading}} such that \\ {c}_{{j}_{most \_ overloading}} = {CV}_{{j}_{most \_ overloading}} ,$$
$$wherein φ ( j , {λ}_{i} ) = \{ \begin{matrix}1 , & if {λ}_{i} = 4 or {λ}_{i} = j \\ 0 , & otherwise\end{matrix} .$$

20. The system of claim 16, further comprising an electricity energy detection device for measuring the real-time available current information related to the main power supply.
